(19) United States
(12) Patent Application Publication
(10) Pub. No.: US 2006/0083224 A1
(43) Pub. Date: Apr. 20, 2006

(54) Intelligent VOIP telephone system and communication method thereof used in a restaurant

(75) Inventors: Shih-Hsiung Weng, Taipei (TW); Poh-Lian Tan, Penang (MY); Poh-Boey Bon, Penang (MY)

Correspondence Address: WELSH & KATZ, LTD, 120 S RIVERSIDE PLAZA, 22ND FLOOR, CHICAGO, IL, 60606, US

(73) Assignee: Inventec Multimedia & Telecom Corporation, Taipei (TW)

(21) Appl. No.: 10/968,753

(22) Filed: Oct. 19, 2004

(51) Int. Cl. H04L 12/66

(52) U.S. Cl. 370/356

(57) ABSTRACT

An intelligent VOIP telephone system and communication method thereof used in a restaurant utilizes a VOIP telephone network to assist the management of the restaurant. The system comprises a main server and at least one VOIP telephone. The main server comprises a document database and a check module. The communication method comprises the following steps: correcting an arranged document in a main server, and transmitting updated data to the VOIP telephone. Then, the VOIP telephone updates the data according to the arranged document. The VOIP telephone gets a request from customers, combines the request and related data to form a packet, and transmits the packet to the main server. Finally, the main server processes the request and sends a confirmation message to the VOIP telephone.

### FIELD OF THE INVENTION

The invention relates to a VOIP telephone system and communication method thereof, and particularly to an intelligent VOIP telephone system and communication method thereof used in a restaurant.

### BACKGROUND OF THE INVENTION

Most restaurants use menus made of paper to introduce dishes and prices. These restaurants need waiters to give service to customers. It takes long time for the waiters to stand next to the customer and write down the dishes the customer orders. If the restaurant has a lot of customers, the waiters often don't have enough time to give good service to every customer.

Because the menus made of paper are easily damaged, the restaurant spends lots of money if it puts a menu on every table or details how the dishes are made in the menu. Besides, if the restaurant often changes its dishes, the oft-replaced menus become another cost.

In addition, another expense of the restaurant is the waiters' salary, but the number of waiters is hard to control. If the restaurant hires too many waiters, the waiters will seem to be too many when business is bad. Otherwise, if the restaurant hires fewer waiters, the waiters will seem to be too few when business is good.

The internet is becoming more and more popular, and most traditional companies have changed their operation procedures to become more digitized. For some time, the development of voice technology has made VOIP (Voice over Internet Protocol) a hot topic in the communication field.

The VOIP uses the basic structure of IP. The VOIP separates data and voice signals into many packets by a packet switching method, then adds the header to the packet in order to give clear indication of the IP addresses of a telephone transmitting end and a telephone receiving end. Then, the telephone transmitting end transmits the packet to the telephone receiving end through the IP addresses and multiples available patches in a store and forward manner. After, the telephone receiving end recombines the received packet to return to the original voice signals. The VOIP service system transmits the data and voice signals by the packet switching method through the internet or special telephone line (like ATM, Frame Relay, etc), to reduce cost.

Although the VOIP transmits data and voice signals simultaneously, the main current of the VOIP is the voice market. Customers only need to dial a local call to an ITSP host in the local area. Then, customers dial a desired long-distance call or international call after a voice prompt by the host. The system connects to the ITSP host where the other party is through the internet, and then dials the other side by a local call. As a result, the customer only needs to pay the local call fee in the local area and the other place, and the ITSP internet fee.

The VOIP seldom applies to traditional businesses, like data transmission in the local network of a restaurant. So, it is necessary to combine the operation procedures of traditional businesses with the VOIP, to provide better service.

### SUMMARY OF THE INVENTION

The object of the invention is to provide an intelligent VOIP telephone system used in restaurant. The system utilizes a VOIP telephone network to assist the management of the smart restaurant. The system integrates an operation procedure of the restaurant with voice transmission of the VOIP telephone network. So, customers can not only dial by the VOIP telephone but also transmit a request by the VOIP telephone network.

The VOIP telephone system comprises a main server and at least one VOIP telephone. The main server comprises a document database and a check module. The document database stores a restaurant operation module. The check module checks a document condition stored in the document database. Every VOIP telephone comprises a service unit and a request module. The service unit supplies a restaurant service interface module to customers. The request module connects the main server and transmits a request generated by the service unit to the main server.

The invention further provides an intelligent VOIP telephone communication method used in a restaurant. First, correct an arranged document in a main server, and transmit updated data to the VOIP telephone. Then, the VOIP telephone updates the data according to the arranged document. Next, the VOIP telephone gets a request from a customer, combines the request and related data to form a packet, and transmits the packet to the main server. Finally, the main server processes the request and sends a confirmed message to the VOIP telephone.

Compared with the prior art, the invention can help business processes of present restaurants become digitized without investing in too much computer hardware. The invention integrates data transmission of the operation procedure and voice requests into the VOIP telephone network. So, the VOIP telephone network can not only dial but also transmit data like an updated menu. If the restaurant utilizes the VOIP telephone system, it no longer needs the paper menus. In addition, the restaurant can hire fewer waiters but supply better service immediately.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a system structure of the disclosed VOIP telephone system;

FIG. 2 is a hardware structure of the disclosed VOIP telephone;

FIG. 3 is a flowchart of the disclosed intelligent VOIP telephone communication method used in a restaurant;

FIG. 4 is a flowchart of a processing procedure when customers order dishes;

FIG. 5 is a flowchart of a processing procedure when customers pay;

FIG. 6 is a flowchart of a processing procedure when downloading an arranged document;

FIG. 7A is a screen display for choosing a TFTP server and arranging parameters;

FIG. 7B is a screen display for showing arranged table numbers;

FIG. 7C is a screen display for showing a list of ordered dishes;

FIG. 7D is a screen display for adding up all of the telephone bills; and

FIG. 7E is a screen display for showing a preparation situation of the ordered menu list.

### DETAILED DESCRIPTION OF THE INVENTION

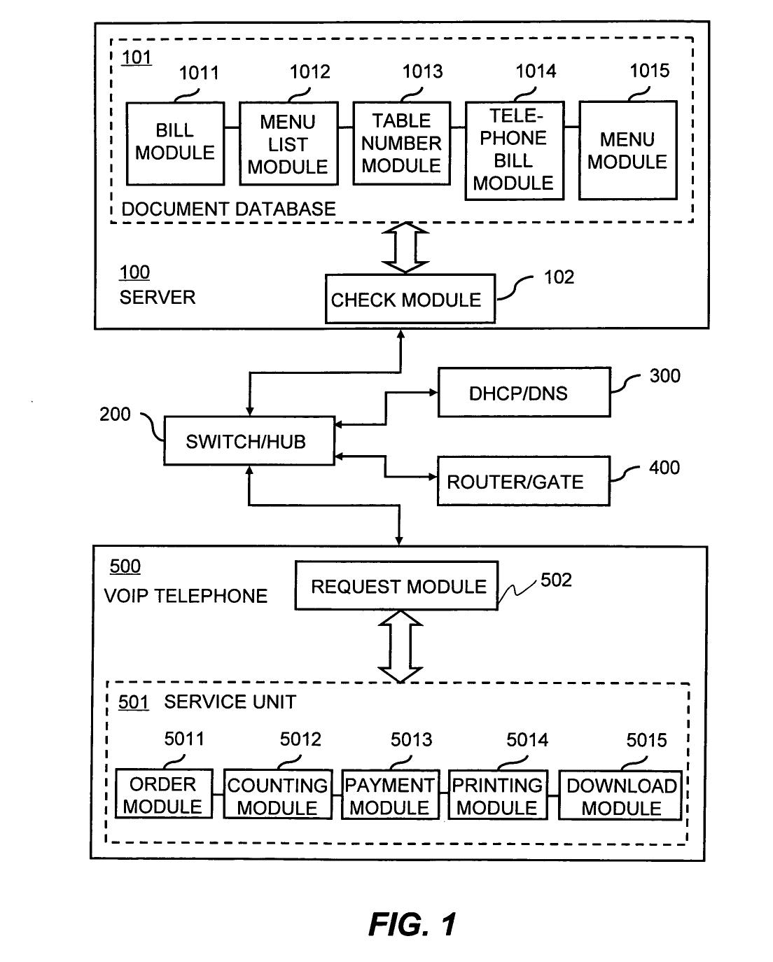

The system structure of the preferred embodiment of the VOIP telephone system is illustrated in FIG. 1. The system includes a main server/TFTP (Trivial File Transfer Protocol) server 100, switch/hub 200, DHCP (Dynamic Host Configuration Protocol)/DNS (Domain Name System) server 300, router/gate 400, and at least one VOIP telephone 500.

The network structure of the invention is flexible. If the VOIP telephone system is a small system, the system can leave out the switch/hub 200, DHCP/DNS server 300 and the router/gate 400. At the same time, the system can use peer-to-peer network to achieve data transmission. The main server, TFTP server, and the DHCP/DNS server can be set up in one computer. For a large-scale network system, these servers can be set up in different computers.

The main server includes a document database 101 and a check module 102. The VOIP telephone includes a service unit 501 and a request module 502.

The document database 101 stores a restaurant operation module. The check module 102 checks a document condition stored in the document database 101. The service unit 501 supplies a restaurant service interface module to customers. The request module 502 connects the main server and transmits a request generated by the service unit 501 to the main server.

The document database 101 comprises a bill module 1011, a menu list module 1012, a table number module 1013, a telephone bill module 1014, and a menu module 1015. The service unit 501 comprises an order module 5011, a counting module 5012, a payment module 5013, a printing module 5014, and a download module 5015.

The bill module 1011 processes a plurality of customers' bills. The menu list module 1012 documents every menu item that customers ordered. The table number module 1013 arranges and stores table numbers in the restaurant. The telephone bill module 1014 counts the customer's IP telephone bill. The menu module 1015 stores a menu. The order module 5101 is for customers to order dishes from the given menu. The counting module 5102 charges the ordered dishes. The payment module 5103 processes customers' payment. The printing module 5104 prints a bill. The download module 5105 downloads updated documents of the document database 101 to the service unit 501.

When the VOIP telephone 500 operates, it requests a network arranged document from the DHCP server 200. The DHCP server 200 distributes an IP address, a subnet mask, a default gateway, a DNS server address, and the name and address of the main server to each VOIP telephone.

If the VOIP telephone 500 does not start using the DHCP service, it requires manual operation to distribute the IP address to each VOIP telephone and arrange the parameters of the main server.

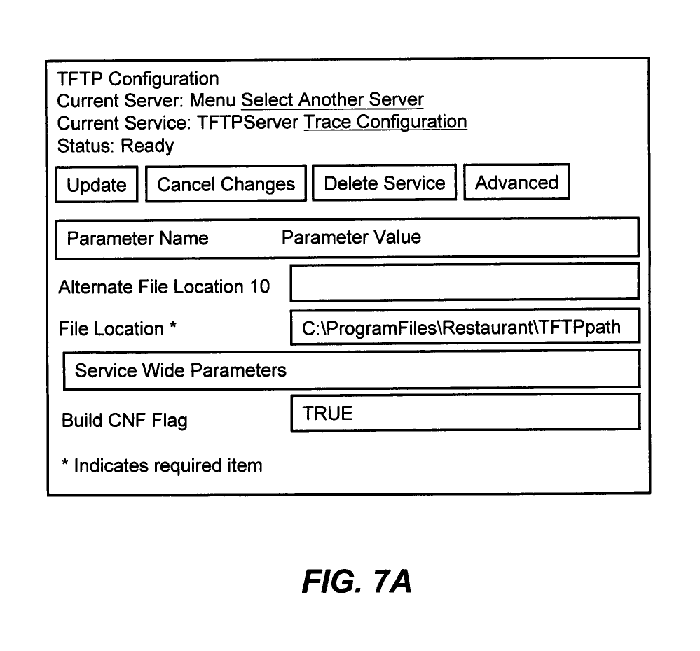

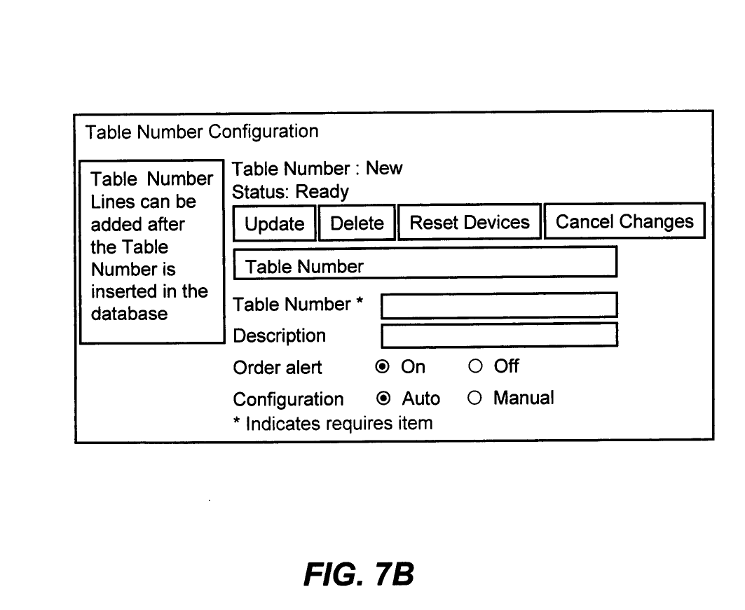

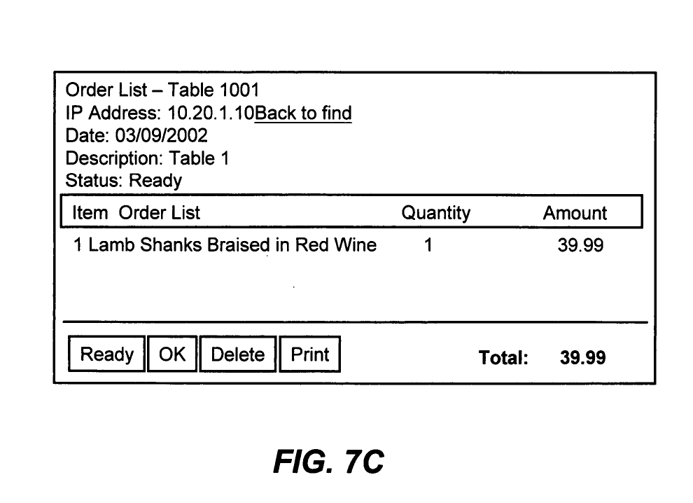

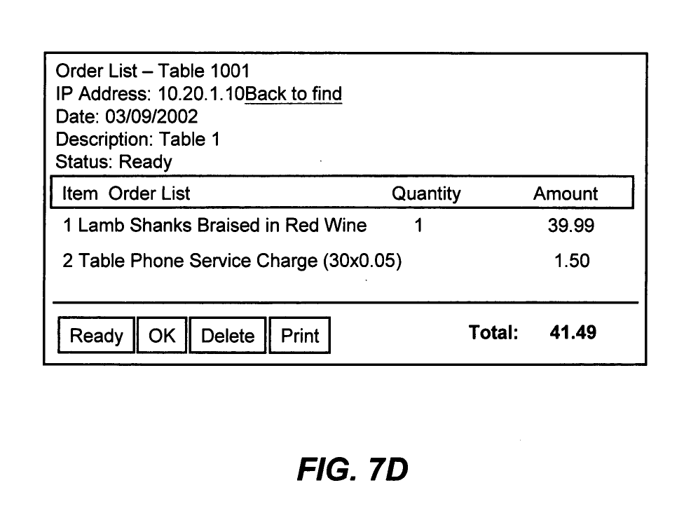

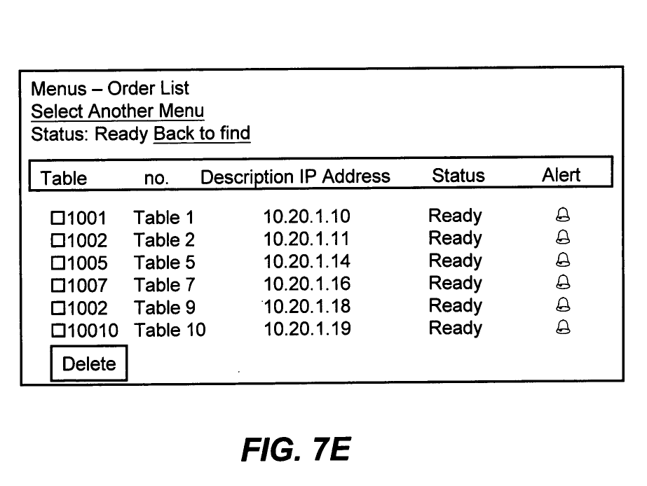

Please refer to FIG. 7A, which illustrates a screen display for choosing a TFTP server and arranging parameters.

The VOIP telephone 500 requests an arranged document from the main server 100 through the request module 502. The main server 100 stores the arranged document (in the form of *.cnf) of the VOIP telephone 500. The arranged document defines connecting parameters between the main server 100 and the VOIP telephone 500. The main server 100 finds the arranged document in the menu module 1015 and determines whether the arranged document has been updated by the check module 102. If the check sum of a menu document stored in the VOIP telephone 500 is the same as that stored in the menu module 1015, then the menu document has not changed. Therefore, the main server 100 does not send the menu document to the VOIP telephone 500. Otherwise, the main server 100 transmits the menu document to the VOIP telephone 500 through the download module 5105. The arranged document defines a communication path between the main server 100 and the VOIP telephone 500. If the VOIP telephone 500 receives the name of the main server 100, it resolves the name by the DNS and connects with the main server 100. Otherwise, the VOIP telephone 500 uses a predefined name of the main server 100 for connecting with the main server 100.

If the main server 100 does not find the arranged document, the main server 100 sends an error message to the VOIP telephone 500 to indicate that it has not found the arranged document.

If the VOIP telephone 500 is unplugged or the main server 100 resets the VOIP telephone 500, the arranged document should be loaded again. The updated document replaces all the documents in the VOIP telephone 500.

If customers ask to pay, the main server 500 generates a bill automatically. Before generating the bill, the main server 100 checks the total price of the ordered dishes counted by the counting module 5012. Then, the main server 100 sends the bill to the customer's VOIP telephone 500 through the internet.

Please refer to FIG. 7E, which illustrates a screen display for showing a preparation situation of the ordered menu list. If customers send the ordered menu list to the main server 100 by the telephone, the main server 100 separates the new menu list from the original one. Then, the new menu list is lined up in order. The menu list comprises the address of the transmitting end (the table number and the IP address). This also helps the waiters to provide the ordered dish to customers correctly. The menu list module 1012 stores the entire ordered menu list. When one of the dishes is prepared, the preparation situation of the dish is changed to complete. When the waiter serves all of the dishes in the menu list, the menu list will be deleted in the waiting list. When the customer is enjoying his or her food, the main server 100 transmits a confirmed message to the VOIP telephone 500. The confirmed message shows the preparation situation of the ordered dishes for the customer to see immediately.

The table number module 1013 stores the table numbers in the main server 100. The table numbers can be updated anytime and arranged automatically or manually. If the table numbers are arranged automatically, the main server 100 distributes the table numbers stored in the table number module 1013 in order. If the table numbers are arranged manually, the customer can choose their table number at random without any repeat. When customers update their table numbers or the VOIP telephone is reconnected, the table number module 1013 arranges the table numbers again.

Please refer to FIG. 7B, which illustrates a screen display for showing the arranged table numbers. The customer can not only enter the table number but also describe the table if necessary. The tables can have buzzers installed. If customers need any service, they only need to push a bottom to inform the waiters.

When the customer dials the VOIP telephone, the telephone bill is recorded and sent to the telephone bill module 1014 in the main server 100. The customer's bill is then updated. The VOIP telephone shows the communication time and bill immediately. When the customer pays, the telephone bill is added to the menu list.

Please refer to FIG. 7D, which illustrates a screen display for adding up all of the telephone bills.

The main server 100 updates the menu stored in the VOIP telephone 500. The customer can see the menu and order dishes through the VOIP telephone 500. All of the VOIP telephones connect with the main server 100. After the customer orders and confirms dishes, all dishes are stored in the memory of the telephone. The bills are counted and shown in the telephone.

After the customer sends the menu list, the menu list is combined with the address of the transmitting end (the table number and the IP address), the data, and the address of the receiving end (the IP address of the main server). Then, the combined data is sent to the main server in the form of packets. The main server sends a confirmation message to the transmitting end according to the current processing situation (i.e., the main server has received the data, the cook is cooking the dish, etc.). The actual response to the confirmed message is different according to the request, and is shown in the telephone to let the customer know that the requested operation is completed.

The menu has a price list. The menu module 1015 in the main server stores the unit price of all dishes. When the customer chooses a dish, a calculator adds up the price. The customer can see the total price of all ordered dishes, to see if they need to add or delete any dishes. Please refer to FIG. 7C, which illustrates a screen display for showing a list of ordered dishes.

After meals, the customer can pay by cash or credit card through the payment module 5103. If the customer pays with the credit card, he or she has to enter a credit card number. Then, the credit card number is sent to the main server for confirmation. The main server 100 sends the credit card number to the credit card center to confirm the number. After confirmation, the main server 100 prints the bill and sends the confirmation message (payment notice). The customer can ask for a receipt at the counter. If the customer pays with cash, he or she can pay at the counter.

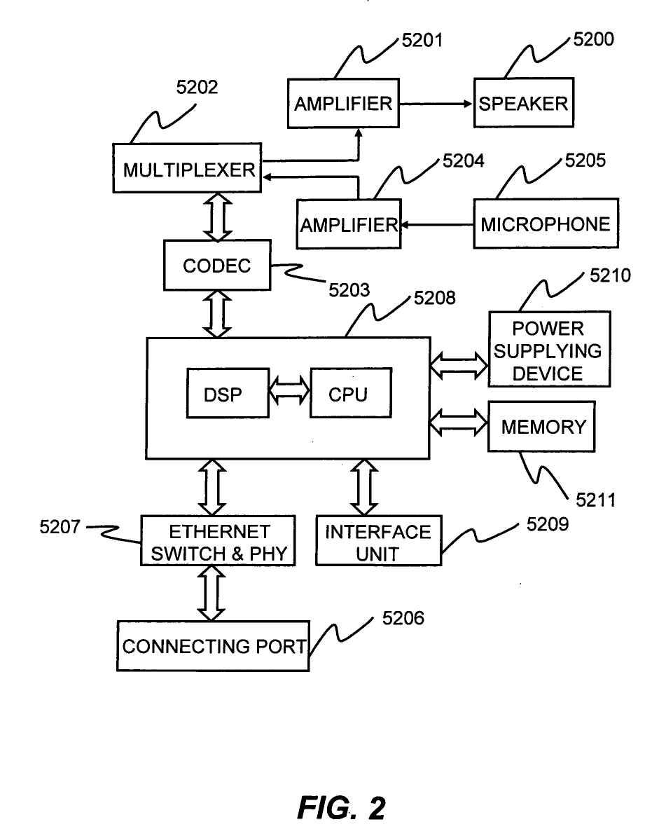

Please refer to FIG. 2, which illustrates a hardware structure of the disclosed VOIP telephone. The VOIP telephone comprises a speaker 5200, a microphone 5205, an Amplifier 5201 and 5204, a multiplexer (MUX) 5202, a codec 5203, Connecting port 5206, Ethernet switch & PHY 5207, a central processing unit (CPU) 5208, an interface unit 5209, power supplying device 5210, and a memory 5211.

The voice and data packets are transmitted to the disclosed VOIP telephone network through the Connecting port 5206. The Ethernet switch & PHY 5207 plays the communication role between the CPU 5208 and external network. A voice packet module of the CPU de-packets the voice packet. Then, the de-packeted voice packet is sent to the Digital Signal Processor (DSP) in the CPU 5208. The DSP processes the voice signals, and the voice signals are transmitted to the codec 5203 of the voice frequency interface. The codec 5203 transforms the digital signals into analog signals. Then, the amplifier 5201 amplifies the analog signals. Finally, the speaker 5200 sounds a human voice. The amplifier 5204 amplifies the input signals of the microphone 5205. Then, the codec 5203 transforms the analog signals into digital signals. Next, the digital signals are processed by the DSP. The voice packet modules of the CPU are packets the voice signals. Then, the packet is transmitted to an external network by the Ethernet switch & PHY 5207. By using the MUX 5202, the customer can receive and transmit voice signals at the same time. The customer can use the keys or display as a user's interface unit 5209 to enter commands or check results. A power supply provides electricity to the VOIP telephone through a port 48 with pins. When the VOIP telephone operates, the DHCP IP address, the subnet mask, the arranged document (*.cnf), the predefined gate, the gate, the router, the IP addresses of the DNS server and the TFTP server are stored in a non-volatile memory unit 5211.

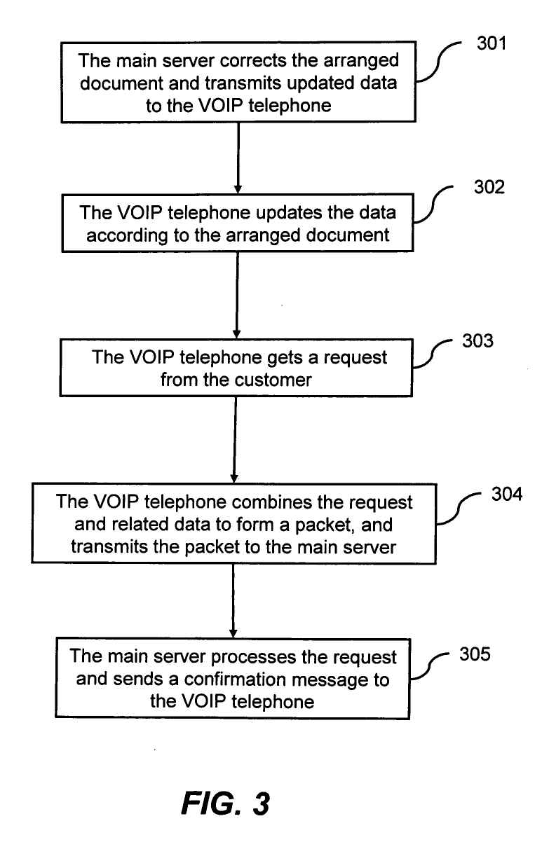

Please refer to FIG. 3, which illustrates a flowchart of the disclosed intelligent VOIP telephone communication method used in the restaurant.

First, the main server corrects the arranged document and transmits updated data to the VOIP telephone (step 301). The arranged document defines connecting parameters between the main server and the VOIP telephone. The check module determines whether the last arranged document and the updated document are the same. If the result is not the same, the main server transmits the updated document to the VOIP telephone. Then, the VOIP telephone updates the data according to the arranged document (step 302). The arranged document comprises the present menu. If the menu is updated, the arranged document updates the menu to the present version. The customers enter a request through an input device following a prompt shown in the service unit of the VOIP telephone. The request comprises an order request, a payment request, and a download request for the arranged document. Then, the VOIP telephone gets a request from the customer (step 303). After that, the VOIP telephone combines the request and related data (like the table number, the IP addresses of the VOIP telephone and the main server) to form a packet, and transmits the packet to the main server (step 304). It matches the request and the address of the VOIP telephone and transmits the data to the main server in the form of packets. Then, the main server processes the request and sends a confirmation message to the VOIP telephone (step 305).

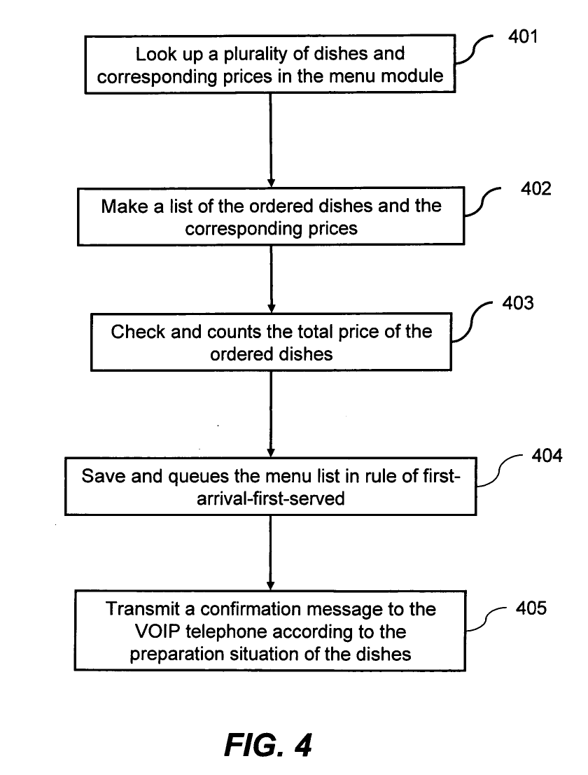

If the main server receives an order request, please refer to FIG. 4, which shows a flowchart of a processing procedure when customers order dishes. First, the main server looks up a plurality of dishes and corresponding prices in the menu module (step 401). Next, it makes a list of the ordered dishes and the corresponding prices (step 402). Then, the counting module checks and counts the total price of the ordered dishes (step 403). After the customer orders from the menu list, the menu list module saves and queues the menu list (step 404). Finally, the main server transmits a confirmation message to the VOIP telephone according to the preparation situation of the dishes (step 405).

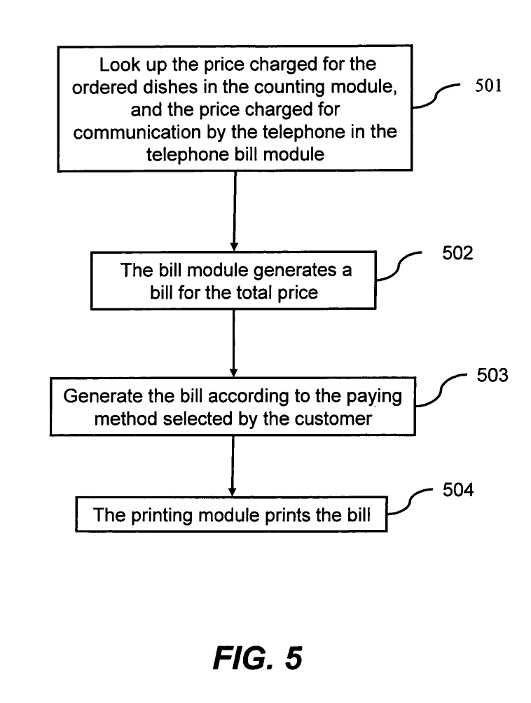

If the main server receives a payment request, please refer to FIG. 5, which shows a flowchart of processing procedures when the customer pays. First, the main server looks up the price charged for the ordered dishes in the counting module, and the price charged for communication by the telephone in the telephone bill module (step 501). Then, the bill module generates a bill for the total price (step 502). The bill is then generated according to the paying method selected by the customer. (step 503). Finally, the printing module prints the bill (step 504).

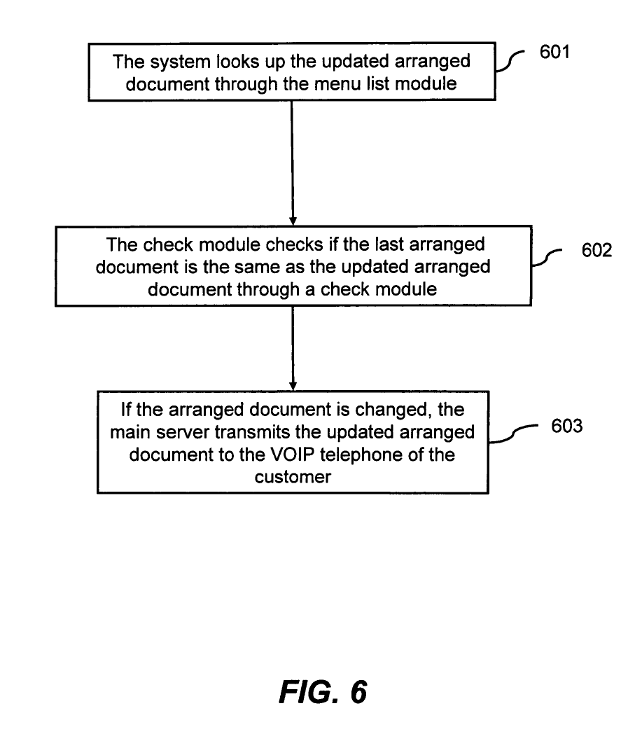

If the main server receives a download request for the arranged document, please refer to FIG. 6, which shows a flowchart of a processing procedure when downloading the arranged document. First, the system looks up the updated arranged document through the menu list module (step 601). The check module checks if the last arranged document is the same as the updated arranged document through a check module (step 602). If the arranged document is changed, the main server transmits the updated arranged document to the VOIP telephone of the customer (step 603).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An intelligent VOIP telephone system used in a restaurant, by using a VOIP telephone network to assist the management of the restaurant, the system comprising a main server and at least one VOIP telephone, the main server comprising:
a document data base, for storing a restaurant operation module;
a check module, for checking a document situation stored in the document database;
the VOIP telephone comprising:
a service unit, for supplying a restaurant service interface module to customers; and
a request module, for connecting the main server and transmitting a request generated by the service unit to the main server.

2. The VOIP telephone system of claim 1, further comprising a DHCP/DNS server, a router /gate and a switch/hub.

3. The VOIP telephone system of claim 1, wherein the restaurant operation module comprising:
a bill module, for processing a plurality of bills of customers;
a menu list module, for documenting every menu that customers ordered;
a table number module, for arranging and storing table numbers in the restaurant;
a telephone bill module, for counting an IP telephone bill of customers; and
a menu module, for storing a menu.

4. The VOIP telephone system of claim 1, wherein the restaurant service interface module comprising:
an order module, for customers to order dishes from the given menu;
a counting module, for charging the ordered dishes;
a payment module, for processing a payment of customers;
a printing module, for printing a bill; and
a download module, for downloading renewed documents of the document data base to the service unit.

5. An intelligent VOIP telephone communication method used in a restaurant, by using a VOIP telephone network to assist the management of the restaurant, the method comprising the following steps of:
correcting an arranged document in a main server, and transmitting a renewed data to the VOIP telephone;
the VOIP telephone updating the data according to the arranged document;
the VOIP telephone getting a request from customers;
the VOIP telephone combining the request and related data to form a packet and transmitting the packet to the main server; and
the main server processing the request and sending a confirmed message to the VOIP telephone.

6. The VOIP telephone communication method of claim 5, wherein the arranged document defines a connecting parameter between the main server and the VOIP telephone.

7. The VOIP telephone communication method of claim 5, wherein the arranged document comprises an updated menu.

8. The VOIP telephone communication method of claim 5, wherein said step for transmitting the updated data to the VOIP telephone is achieved by checking if the last arranged document and the updated arranged document are the same by a check module and sending the updated arranged document to the VOIP telephone if two documents are not the same.

9. The VOIP telephone communication method of claim 5, wherein said step for getting a request from customers is to get a request command entered by customers through a VOIP service unit.

10. The VOIP telephone communication method of claim 5, wherein the request comprises an order request, a payment request, and a download request for the arranged document.

11. The VOIP telephone communication method of claim 5, wherein the related data comprises a table number, the VOIP telephone and an IP address of the main server.

12. The VOIP telephone communication method of claim 5, wherein said step for combining the request and related data to form the packet is to match the request to the address data of the VOIP telephone, and then transmit the request and related data to the main server in the form of the packet.

13. The VOIP telephone communication method of claim 5, wherein said step for processing the request if the request is an order request, the step comprises the following steps:
looking up a plurality of dishes and corresponding prices in a menu module;
making a list of the ordered dishes and the corresponding prices;
checking a total price of the ordered dishes counted by a counting module;
saving and queuing the menu list in the menu list module after customers proposing the menu list; and
transmitting a confirmed message to the VOIP telephone according to the preparation situation of the dishes.

14. The VOIP telephone communication method of claim 13, wherein the confirmed message comprising a message of receiving the menu list, a message of preparing the dishes, a message of completing the dishes and a message of canceling the ordered dish.

15. The VOIP telephone communication method of claim 5, wherein said step for processing the request if the request is a payment request, the step comprises the following steps:
looking up the price charged for the ordered dishes in a counting module and the price charged for the communication by the telephone in a telephone bill module;
generating a bill of the total price by a bill module;
paying the bill according to the way of the payment; and
printing the bill by a printing module.

16. The VOIP telephone communication method of claim 5, The VOIP telephone communication method of claim 5, wherein said step for processing the request if the request is a download request for the arranged document, the step comprises the following steps:
looking up the updated arranged document through a menu list module;
checking if the last arranged document is the same as the updated arranged document through a check module; and
transmitting the updated arranged document to the VOIP telephone of a request end if the arranged document is changed.
